(19) United States
(12) Patent Application Publication
(10) Pub. No.: US 2007/0079101 A1
(43) Pub. Date: Apr. 5, 2007

(54) Storage control apparatus and storage control method

(75) Inventor: Kazuma Takatsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/342,972

(22) Filed: Jan. 31, 2006

(30) Foreign Application Priority Data
Oct. 4, 2005 (JP) 2005-290671

(51) Int. Cl. G06F 12/00

(52) U.S. Cl. 711/170

(57) ABSTRACT

An apparatus by comprising respective units for receiving, from a hierarchical control server for controlling a library, a creation instruction signal which instructs an creation of a VLU in a disk array; for creating a VLU in the disk array based on the creation instruction signal; for transmitting, to the hierarchical control server, a complete signal indicating a completion when the VLU has been created; for transmitting, to hierarchical control server, a read-out request which requests for reading a specific data in order to recognize a LUN out of the library based on the creation instruction signal; for reading the specific data out of the library based on the transmitted read-out request; for controlling so as to store the readout specific data in the library; and for transmitting the stored data in the library to the host apparatus based on a request therefrom.

### BACKGROUND OF THE INVENTION

1. Field of the Invention

The present invention relates to a storage control apparatus and storage control method for controlling a readout of data stored by a high capacity and low speed access external storage apparatus such as a magnetic disk, and in particular to a storage control apparatus and storage control method which are capable of effectively transmitting data stored by a storage apparatus to a host server, that is, the data reader by way of a low capacity and high speed access storage apparatus.

2. Description of the Related Art

Conventionally, a storage control apparatus for controlling a large capacity and yet low speed access external storage apparatus, such as a magnetic disk, magneto optical disk and optical disk, controls the external storage apparatus based on a request from a host server. Such a storage control apparatus is variously devised as follows in order to access to an external apparatus effectively.

For instance, a laid-open Japanese patent application publication No. 01-92855 relates to a disk cache control method for carrying out an access to a disk apparatus, which is capable of a high speed access by letting a cache memory read out and retain disk management information in advance, pre-reading out of the disk apparatus and also allocating the cache memory dynamically to the disk apparatus or a virtual disk apparatus in a specified aspect on as required basis.

And, a laid-open Japanese patent application publication No. Sho 60-254220 has disclosed an optical disk control method by using a paging which handles a magnetic disk as an auxiliary disk for a computer connected optical disk subsystem and virtualizes an optical disk, by paging, as a large capacity random access storage apparatus which is equivalent to the magnetic disk.

And, another laid-open Japanese patent application publication No. Sho 58-5865 has disclosed a technique for enabling an access to file data by one seek operation by equipping a semiconductor memory in order to store volume catalog data for indicating a position of the file data in a magnetic disk, writing the volume catalog data out of the magnetic disk in the semiconductor memory at the time of a system startup, referring to the data in the semiconductor memory at the ensuing time of accessing to the file data and carrying out a seek operation for a file area.

And yet another laid-open Japanese patent application publication No. 09-50348 has disclosed a technique which is capable of shortening a file access time without changing an application program for carrying out a file access by requesting an external storage apparatus set up a logic file therein, and also comprising an application program for specifying the number of physical files corresponding to the logic file, a physical file writing position determination unit for determining a setup position of the physical file by receiving a request from the application program for setting up a logic file anew and the number of physical files corresponding to the logic file, and a physical file writing unit for setting up a physical file in a position determined by the physical file writing position determination unit.

The above noted conventional technique, however, has been faced with the problem of not adequately shortening a readout time of data, which is purported by a host server.

### SUMMARY OF THE INVENTION

In consideration of the above noted situation, the purpose of the present invention is to provide a storage control apparatus and storage control method capable of shortening the time for a host server reading data out of an external storage apparatus in great deal.

The present invention has adopted the below described comprisal in order to solve the above noted problem.

That is, according to one aspect of the present invention, a storage control apparatus thereof comprises: a virtual logical unit creation instruction receiving unit for receiving, from a hierarchical control server for controlling the external storage apparatus, a virtual logical unit creation instruction signal which instructs a creation of a virtual logical unit in the storage apparatus; a virtual logical unit creation unit for creating a virtual logical unit in the storage apparatus based on a virtual logical unit creation instruction signal received by the virtual logical unit creation instruction receiving unit; a virtual logical unit creation complete signal transmission unit for transmitting, to the hierarchical control server, a virtual logical unit creation complete signal which indicates that a virtual logical unit has been created when the virtual logical unit creation unit has created the virtual logical unit; a readout request transmission unit for transmitting, to the hierarchical control server, a readout request which requests a readout of specific data out of the external storage apparatus in order to recognize the logical unit number of the virtual logical unit based on the virtual logical unit creation instruction signal received by the virtual logical unit creation unit; a data readout unit for reading the specific data out of the external storage apparatus under a control of the hierarchical control server based on the readout request transmitted by the readout request transmission unit; a storage control unit for controlling so as to store the specific data read out by the data readout unit in the storage apparatus; and a data transmission unit for transmitting the specific data stored by the storage apparatus to the host server based on the request therefrom.

According to another aspect of the present invention, a storage control method thereof is the one carried out by a storage control apparatus for transmitting, to a host server, data stored by a large capacity and low speed access external storage apparatus following transferring the data to a small capacity and high speed access storage apparatus based on a request from the host server, comprising the steps of receiving, from a hierarchical control server for controlling the external storage apparatus, a virtual logical unit creation instruction signal which instructs a creation of a virtual logical unit in the storage apparatus; creating a virtual logical unit in the storage apparatus based on the received virtual logical unit creation instruction signal; transmitting, to the hierarchical control server, a virtual logical unit creation complete signal which indicates that a virtual logical unit has been created when the virtual logical unit has been created; transmitting, to the hierarchical control server, a readout request which requests a readout of specific data out of the external storage apparatus in order to recognize the logical unit number of the virtual logical unit based on the received virtual logical unit creation instruction signal; reading the specific data out of the external storage apparatus under a control of the hierarchical control server based on the transmitted readout request; controlling so as to store the read-out specific data in the storage apparatus; and transmitting the specific data stored by the storage apparatus to the host server based on the request therefrom.

### BRIEF DESCRIPTION OF THE DRAWINGS

FIG. 1 shows a comprisal of the entire system including a storage control apparatus applied by the present invention;

FIG. 2 is a sequence diagram (part 1) showing a flow of a conventional storage control;

FIG. 3 is a sequence diagram (part 1) in order to describe a storage control method applied by the present invention;

FIG. 4 is a flow chart showing a flow of a storage control processing applied by the present invention;

FIG. 5 is a sequence diagram (part 2) in order to describe a storage control method applied by the present invention; and

FIG. 6 is a sequence diagram (part 2) showing a flow of a conventional storage control.

### DESCRIPTION OF THE PREFERRED EMBODIMENTS

The following is a detailed description of the preferred embodiment of the present invention while referring to the accompanying drawings.

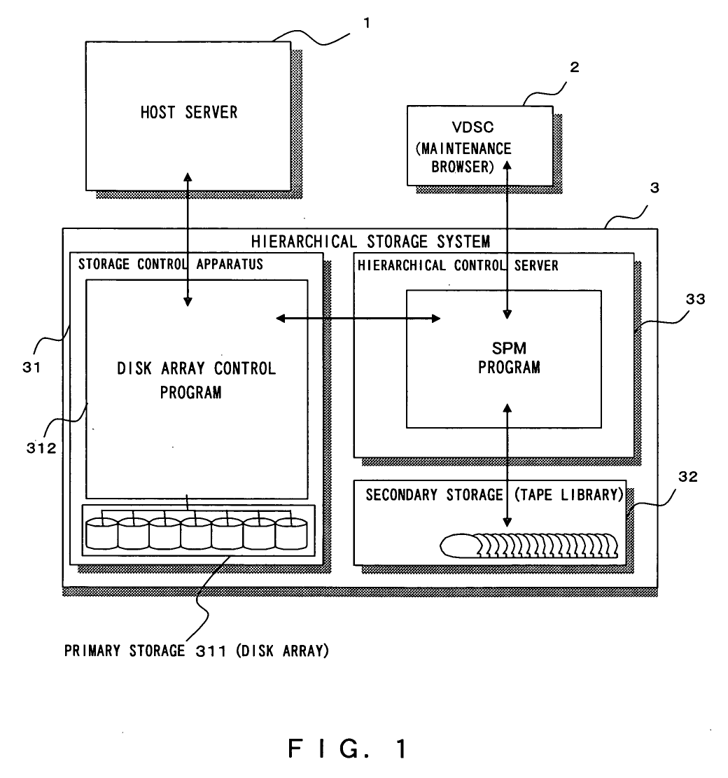

FIG. 1 shows a comprisal of the entire system including a storage control apparatus applied by the present invention.

Referring to FIG. 1, a host server 1 is connected to a hierarchical storage system 3 which comprises a storage control apparatus 31, a secondary storage (i.e., a tape library) 32, that is, a large capacity (e.g., 8 petabytes) and low speed access external storage apparatus, and a hierarchical control server 33.

The storage control apparatus 31 is an equipment for transmitting, to the host server 1, data stored by the secondary storage 32 following transferring the data to a primary storage (i.e., a disk array) 311 that is a small capacity (e.g., 36 terabytes) and high speed access storage apparatus based on a request from the host server 1.

And the storage control apparatus 31 comprises the primary storage 311 and a disk array control program 312 which comprises a virtual logical unit creation instruction receiving unit, a virtual logical unit creation unit, a virtual logical unit creation complete signal transmission unit, a readout request transmission unit, a data readout unit, a storage control unit and a data transmission unit.

The virtual logical unit creation instruction receiving unit receives, from an SPM (storage pyramid management) program comprised by the hierarchical control server 33, a virtual logical unit creation instruction signal for instructing a creation of a virtual logical unit (VLU) in the primary storage 311. Note that the SPM program is software for carrying out a control of the secondary storage 32, a transmission & receiving of data between the primary storage 311 and secondary storage 32, a management of configuration information relating to a hierarchical storage comprising the storage control apparatus 31 and the secondary storage 32, et cetera. A configuration definition, maintenance, etcetera, of the hierarchical storage are carried out by software (i.e., a maintenance browser) which is called as a VDSC (virtual disk service console) 2.

The virtual logical unit creation unit creates a virtual logical unit in the primary storage 311 based on a based on a virtual logical unit creation instruction signal received by the virtual logical unit creation instruction receiving unit, and the virtual logical unit creation complete signal transmission unit transmits, to the hierarchical control server 33, a virtual logical unit creation complete signal which indicates that a virtual logical unit has been created when the virtual logical unit creation unit has created the virtual logical unit.

The readout request transmission unit transmits, to the hierarchical control server 33, a read-out request which requests a read-out of the data out of the secondary storage 32 based on the virtual logical unit creation instruction signal received by the virtual logical unit creation unit.

The data readout unit reads the data out of the secondary storage 32 under a control of the SPM program based on the readout request transmitted by the readout request transmission unit.

The storage control unit controls so as to store the data read out by the data readout unit in the storage apparatus, and the data transmission unit transmits the data stored by the virtual logical unit to the host server 1 based on the request therefrom.

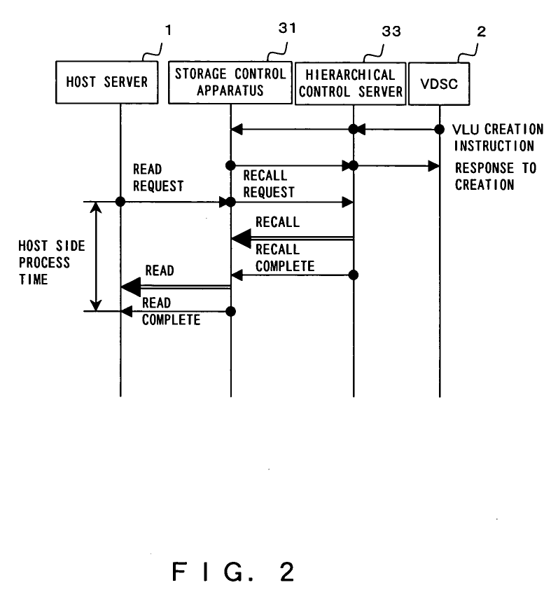

FIG. 2 is a sequence diagram (part 1) showing a flow of a conventional storage control.

First, as the VDSC 2 instructs the storage control apparatus 31 to create a virtual logical unit (VLU) (i.e., a VLU creation instruction) by way of the hierarchical control server 33 comprising the SPM program, the storage control apparatus 31 creates a virtual logical unit (i.e., a response to the creation instruction).

Then, when a readout request of data (read request) is generated by the host server 1, the storage control apparatus 31 carries out a recall (i.e., a data readout from the secondary storage 32 to the primary storage 311) to the hierarchical control server 33. Here, a processing time of anywhere between several seconds and several minutes is required for the host server 1 starting a data read-out to the finish.

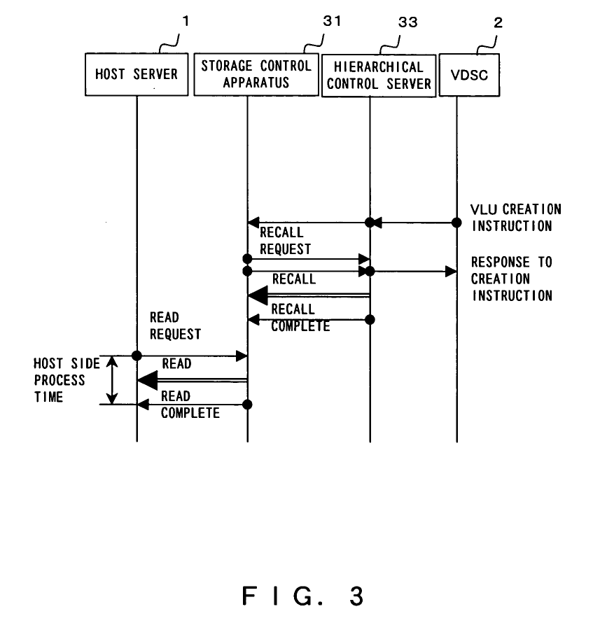

FIG. 3 is a sequence diagram (part 1) in order to describe a storage control method applied by the present invention.

Referring to FIG. 3, as the VDSC 2 instructs the storage control apparatus 31 to create a virtual logical unit (VLU) (i.e., a VLU creation instruction) by way of the hierarchical control server 33 comprising the SPM program, the storage control apparatus 31 recalls a specific area used by the host server 1 in order to recognize a LUN (logical unit number) simultaneously with a new creation of a LUN, in parallel with a creation of a virtual logical unit (i.e., a response to the creation instruction).

And, since a recall is already complete when a read-out request (i.e., a read request) for data is generated by the host server 1, the process time thereat from a data read-out to the finish is shortened to less than one second as compared to several seconds to several minutes conventionally.

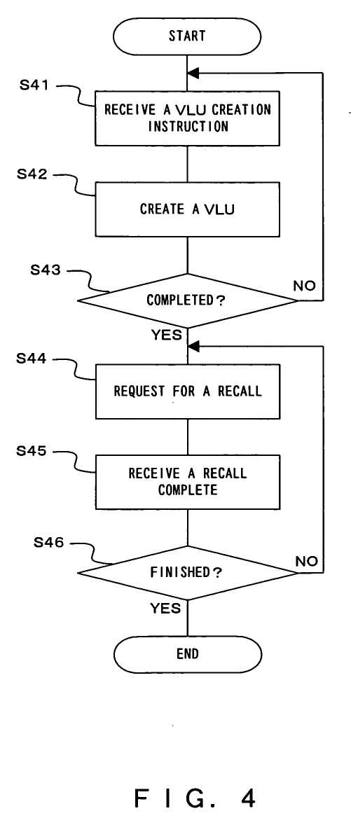

FIG. 4 is a flow chart showing a flow of a storage control processing applied by the present invention.

The present storage control processing is carried out by the storage control apparatus 31 for transmitting, to a host server 1, data stored by the secondary storage 32, which is a large capacity and low speed access external storage apparatus, following transferring the data to the primary storage 311, which is a small capacity and high speed access storage apparatus, based on a request from the host server 1.

First, the step S41 is to receive, from the hierarchical control server 33 for controlling the secondary storage 32, a virtual logical unit creation instruction signal which instructs a creation of a virtual logical unit (VLU) in the primary storage 311.

Then, the step S42 is to create a virtual logical unit in the primary storage 311 based on the virtual logical unit creation instruction signal received in the step S41 and transmits, to the hierarchical control server 33, a virtual logical unit creation complete signal which indicates that a virtual logical unit has been created.

And, the step S43 is to judge whether or not a creation of a virtual logical unit has been completed. If the judgment is “not completed” (i.e., “no” for the step S43), the process goes back to the step S41, while if the judgment is “complete” (i.e., “yes” for the step S44) the process proceeds to the step S44.

The step S44 is to transmit, to the hierarchical control server 33, a read-out request which requests a read-out of the data requested by the host server 1 out of the secondary storage 32 based on the virtual logical unit creation instruction signal received in the step S41.

Next, the step S45 is to read the data out of the secondary storage 32 under a control of the hierarchical control server 33 based on the readout request transmitted in the step S44, control so as to store the readout data in the virtual logical unit and transmit the data stored therein to the host server 1 based on the above described request.

Then, the step S46 is to judge whether or not a recall is finished. If the judgment is “not finished” (i.e., “no” for the step S46), the process goes back to the step S45, while if the judgment is “finished” (i.e., “yes” for the step S46), the present storage control processing ends.

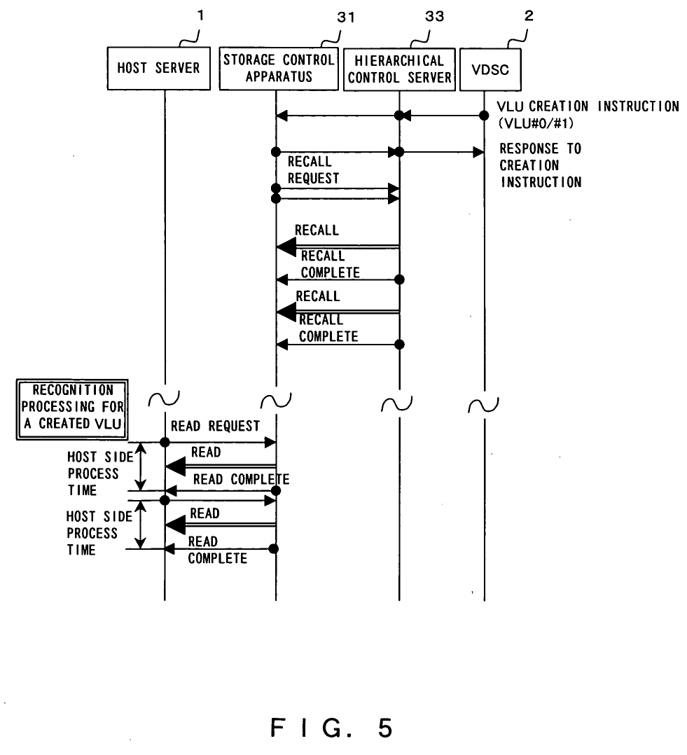

FIG. 5 is a sequence diagram (part 2) in order to describe a storage control method applied by the present invention.

The sequence diagram shown by FIG. 5 differs from the one shown by FIG. 3 where plural times (i.e., 2 times) of read requests (i.e., a creation of a plurality of VLUS) are carried out, otherwise the basic sequences are the same.

That is, as the VDSC 2 instructs (i.e., a VLU creation instruction) the storage control apparatus 31 to create two virtual logical units (#0 and #1) by way of the hierarchical control server 33 comprising the SPM program, the storage control apparatus 31 recalls a specific area used by the host server 1 for recognizing a LUN twice at the same time of new creation of the LUN in parallel with creating two virtual logical units (i.e., a response to the creation instruction).

Then, since the first recall is already completed when the first data readout request (i.e., a read request) is generated by the host server 1 and the second recall is already completed when the second data readout request (i.e., a read request) is generated by the host server 1, the process time required for the host server 1 from a data readout to the finish is shortened in great deal.

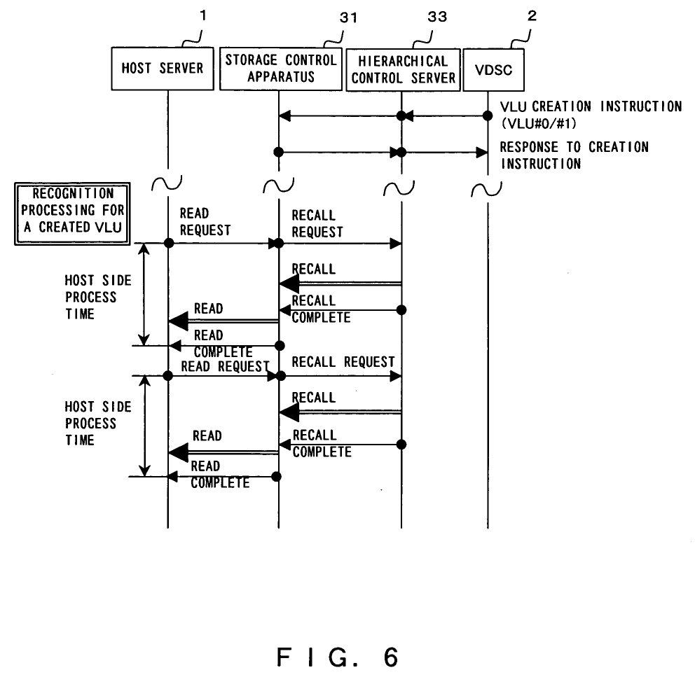

FIG. 6 is a sequence diagram (part 2) showing a flow of a conventional storage control.

The sequence diagram shown by FIG. 6 exemplifies a sequence for carrying out plural times (i.e. 2 times) of read requests (i.e., a creation of a plurality of VLUs) as described above by referring to FIG. 5.

First, as the VDSC 2 instructs (i.e., a VLU creation instruction) the storage control apparatus 31 to create two virtual logical units (VLUs) by way of the hierarchical control server 33 comprising the SPM program, the storage control apparatus 31 creates two virtual logical units (i.e., a response to the creation instruction).

Subsequently, when the first data readout request (i.e., a read request) is generated by the host server 1, the storage control apparatus 31 carries out the first recall to the hierarchical control server 33. Then, when the second data readout request (i.e., a read request) is generated by the host server 1, the storage control apparatus 31 carries out the second recall to the hierarchical control server 33. Therefore, a great deal of processing time is required for the host server 1 from a data readout to the finish.

As such, while the storage control apparatus 31 and the storage control method both applied by the present invention have been described, one of the most remarkable characteristics of the present invention is to schedule so as to carry out a recall processing (i.e., a data readout processing from the secondary storage 32 to the primary storage 311) of a specific area used by the host server 1 for recognizing a logical unit number at the same time of newly creating the logical unit number.

In order for the host server 1 to recognize the logical unit number that is newly created, an access to a specific area of the logical unit number is carried out generally for writing a label, et cetera, hence the processing is carried out sequentially. Therefore, in the case of creating a plurality of virtual logical units at the same time, a long period of time is consumed for the host server recognizing the logical unit numbers if a recall is generated every time a logical unit number is accessed.

However, the present invention makes it possible to eliminate an access to the secondary storage 32 by the host server 1 for a logical unit number recognition processing by recalling a specific area temporarily in the primary storage 311 at the same time of newly creating a virtual logical unit, thereby enabling a performance improvement.

Accordingly, the present invention makes it possible to shorten the time for a host server reading data out of an external storage apparatus in great deal.

What is claimed is:

1. A storage control apparatus for transferring data stored by a large capacity and low speed access external storage apparatus to a small capacity and high speed access storage apparatus followed by transmitting the data to a host server based on a request therefrom, comprising:
a virtual logical unit creation instruction receiving unit for receiving, from a hierarchical control server for controlling the external storage apparatus, a virtual logical unit creation instruction signal which instructs a creation of a virtual logical unit in the storage apparatus;
a virtual logical unit creation unit for creating a virtual logical unit in the storage apparatus based on a virtual logical unit creation instruction signal received by the virtual logical unit creation instruction receiving unit;
a virtual logical unit creation complete signal transmission unit for transmitting, to the hierarchical control server, a virtual logical unit creation complete signal which indicates that a virtual logical unit has been created when the virtual logical unit creation unit has created the virtual logical unit;
a readout request transmission unit for transmitting, to the hierarchical control server, a read-out request which requests a readout of specific data out of the external storage apparatus in order to recognize the logical unit number of the virtual logical unit based on the virtual logical unit creation instruction signal received by the virtual logical unit creation unit;
a data readout unit for reading the specific data out of the external storage apparatus under a control of the hierarchical control server based on the readout request transmitted by the readout request transmission unit;
a storage control unit for controlling so as to store the specific data read out by the data readout unit in the storage apparatus; and
a data transmission unit for transmitting the specific data stored by the storage apparatus to the host server based on the request therefrom.

2. A storage control method carried out by a storage control apparatus for transmitting, to a host server, data stored by a large capacity and low speed access external storage apparatus following transferring the data to a small capacity and high speed access storage apparatus based on a request from the host server, comprising the steps of
receiving, from a hierarchical control server for controlling the external storage apparatus, a virtual logical unit creation instruction signal which instructs a creation of a virtual logical unit in the storage apparatus;
creating a virtual logical unit in the storage apparatus based on the received virtual logical unit creation instruction signal;
transmitting, to the hierarchical control server, a virtual logical unit creation complete signal which indicates that a virtual logical unit has been created when the virtual logical unit has been created;
transmitting, to the hierarchical control server, a readout request which requests a readout of specific data out of the external storage apparatus in order to recognize the logical unit number of the virtual logical unit
based on the received virtual logical unit creation instruction signal;
reading the specific data out of the external storage apparatus under a control of the hierarchical control server based on the transmitted readout request;
controlling so as to store the readout specific data in the storage apparatus; and
transmitting the specific data stored by the storage apparatus to the host server based on the request therefrom.
